(19) United States
(12) Patent Application Publication
(10) Pub. No.: US 2009/0256880 A1
(43) Pub. Date: Oct. 15, 2009

(54) PRINTING SYSTEM, INKJET PRINTER AND METHOD FOR PRINTING

(75) Inventor: Masaru OHNISHI, Tomi-city (JP)

Correspondence Address: DITTHAVONG MORI & STEINER, P.C., 918 Prince St., Alexandria, VA, 22314, US

(73) Assignee: MIMAKI ENGINEERING CO., LTD., Tomi-city (JP)

(21) Appl. No.: 12/419,282

(22) Filed: Apr. 6, 2009

(30) Foreign Application Priority Data
Apr. 9, 2008 (JP) 2008-101058

(51) Int. Cl. B41J 29/38

(52) U.S. Cl. 347/17

(57) ABSTRACT

A printing system includes an inkjet head, a medium supporting portion and a decompressor. The inkjet head has nozzles configured to eject ink to a print surface of a medium. The nozzles have a nozzle surface on which openings of the nozzles exist. The medium supporting portion has a supporting surface configured to support the medium at a back surface of the medium opposite to the print surface. The print surface faces the nozzles of the inkjet head. A distance between the nozzle face and the supporting surface of the medium supporting portion is about 5 mm or more. The decompressor is configured to reduce a pressure in an area between the medium and the nozzles to be a pressure value lower than atmospheric pressure.

### CROSS-REFERENCE TO RELATED APPLICATIONS

The present application claims priority under 35 U.S.C. § 119 to Japanese Patent Application No. 2008-101058, filed Apr. 9, 2008. The contents of this application are incorporated herein by reference in their entirety.

### BACKGROUND OF THE INVENTION

1. Field of the Invention

The present invention relates to a printing system, an inkjet printer, and a method for printing.

2. Discussion of the Background

Recently, a technology for printing a high resolution image by means of an inkjet printer has been widely used. The inkjet printer is an apparatus in which minuscule droplets of ink are ejected from nozzles of an inkjet head toward a medium so as to conduct printing on the medium.

In an inkjet printer, ink droplets ejected from nozzles are subjected to air resistance until reaching a medium. As the distance between the nozzles and the medium is increased, the influence of the air resistance is also increased so that it is hard to conduct suitable printing. Accordingly, the distance between the nozzles and the medium is set to be small such as several millimeters (for example, about 2-3 mm).

As the distance between the nozzles and the medium is reduced without any measurement, there is a risk that the medium may collides with the inkjet head. Therefore, inkjet printers are provided with various mechanisms for preventing such collision between the medium and the inkjet head. As one of such mechanisms, a mechanism including a plurality of rollers assembled with high accuracy is employed.

However, employment of such a mechanism may complexify the design of the inkjet printer. Therefore, it is desired to prevent the design of printing systems from becoming complex. Further, complexified mechanism may decrease the reliability due to failure, faulty component or the like, and decrease the maintainability. It is therefore further desired to provide a printing system having improved reliability and improved maintainability. Especially in industrial inkjet printers, it is desired to minimize causes of reducing the reliability and the maintainability.

JP-A-2004-134490 discloses an apparatus using an inkjet head which ejects ink to a substrate. In this apparatus, ink ejected from the inkjet head passes through an area where a pressure is lower than an atmospheric pressure.

### SUMMARY OF THE INVENTION

According to one aspect of the present invention, a printing system includes an inkjet head, a medium supporting portion, and a decompressor. The inkjet head has nozzles configured to eject ink to a print surface of a medium. The nozzles have a nozzle surface on which openings of the nozzles exist. The medium supporting portion has a supporting surface configured to support the medium at a back surface of the medium opposite to the print surface. The print surface faces the nozzles of the inkjet head. A distance between the nozzle face and the supporting surface of the medium supporting portion is about 5 mm or more. The decompressor is configured to reduce a pressure in an area between the medium and the nozzles to be a pressure value lower than atmospheric pressure.

According to another aspect of the present invention, an inkjet printer includes an inkjet head and a medium supporting portion. The inkjet head has nozzles configured to eject ink to a print surface of a medium. The nozzles have a nozzle surface on which openings of the nozzles exist. A pressure in an area between the medium and the nozzles is reduced to be a pressure value lower than atmospheric pressure. A medium supporting portion has a supporting surface configured to support the medium at a back surface of the medium opposite to the print surface. The print surface faces the nozzles of the inkjet head. A distance between the nozzle face and the supporting surface of the medium supporting portion is about 5 mm or more.

According to the other aspect of the present invention, a method for printing includes supporting a medium at a back surface of the medium opposite to a print surface. A distance between a nozzle surface on which openings of nozzles exist and a supporting surface supporting the medium is about 5 mm or more. A pressure in an area between the medium and the nozzles is reduced to be a pressure value lower than atmospheric pressure. Ink is ejected from the nozzles to the print surface of the medium.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a printing system according to an embodiment of the present invention;

FIG. 2 is a graph for explaining the relationship between the kinetic energy of an ink droplet and air resistance;

FIGS. 3A and 3B are illustrations showing an example of influence of air resistance on ink droplets, wherein FIG. 3(a) schematically shows an example of state of an ink droplet ejected from the inkjet head which is moving in the Y direction, and wherein FIG. 3(b) schematically shows an example of state of an ink droplet in case that the ink is ejected in a horizontal direction; and

FIGS. 4A and 4B are illustrations for explaining the flying distance of the ink droplet, wherein FIG. 4A is a graph showing an example of relationship between the radius of the droplet and the maximum flying distance under the normal atmospheric pressure, and wherein FIG. 4B is a table showing an example of relationship between the pressure in the area between the nozzle of the inkjet head and the medium and the maximum flying distance of the droplet.

### DESCRIPTION OF THE EMBODIMENT

Embodiments will now be described with reference to the accompanying drawings, wherein like reference numerals designate corresponding or identical elements throughout the various drawings.

An embodiment of the present invention may include the following arrangements.

(Arrangement 1) A printing system of a type printing in the inkjet method, includes: an inkjet head having nozzles for ejecting ink to a medium; a medium supporting portion for supporting the medium to face the nozzles of the inkjet head by supporting the back surface of the medium opposite to the print surface; and a decompression means for reducing the pressure of at least an area between the medium and the nozzles of the inkjet head to a value lower than the normal atmospheric pressure, wherein the distance between the surface for supporting the medium of the medium supporting portion and the nozzle face of the inkjet head is about 5 mm or more. The decompression means preferably reduces the pressure of at least whole area between the medium and the nozzles. The medium is a plane (two-dimensional) medium such as paper, film, or fabric.

To prevent collision between the medium and the inkjet head, it can be considered that increasing the distance therebetween is effective. However, ink droplets ejected from the nozzles of the inkjet head are subjected to air resistance until reaching the medium. As the distance for reaching the medium is increased, the problem that the deposition point is shifted and the problem that the ink droplet becomes fine mist are increased so that it is difficult to conduct suitable printing in the inkjet method.

However, the arrangement 1 as mentioned above can adequately reduce the influence of air resistance by decompression. In addition, this allows the distance between the nozzle face of the inkjet head and the medium to be set adequately large. According to the arrangement, therefore, the collision between the medium and the inkjet head can be suitably prevented without using a complex mechanism or the like. Further, it is possible to provide a printing system having high reliability and high maintainability.

The distance between the surface for supporting the medium of the medium supporting portion and the nozzle face of the inkjet head is, for example, the minimum distance between the surface of the medium supporting portion which is in contact with the medium and the nozzle face of the inkjet head. The nozzle face of the inkjet head is, for example, a face, in which openings of the nozzles exist, of the inkjet head. The minimum distance between the print surface of the medium, supported by the medium supporting portion, and the nozzle face may be, for example, about 4 mm or more, preferably from about 5 mm or more.

(Arrangement 2) The distance between the surface for supporting the medium of the medium supporting portion and the nozzle face is about 10 mm or more. According to this arrangement, the collision between the medium and the inkjet head can be more suitably prevented. The minimum distance between the print surface of the medium and the nozzle face is, for example, about 9 mm or more, preferably about 10 mm or more.

(Arrangement 3) The inkjet head ejects ink droplets, each having a volume of about 3 picoliters or less, from the nozzles. According to this arrangement, adequate printing of a high resolution image can be conducted with preventing the medium and the inkjet head from colliding with each other.

The smaller the size of the ink droplet is, the greater the influence of air resistance on the ink droplet is. As the volume of the ink droplet is small, it is difficult to make the distance between the nozzle face and the medium large in the atmosphere. According to the arrangement 3, however, the distance between the nozzle face and the medium can be set adequately large even when the volume of the ink droplet is small. Further, this adequately prevents the collision between the medium and the inkjet head.

The volume of the ink droplet is preferably 1 picoliter (hereinafter, referred to as “pl”) or less, more preferably 0.5 pl or less, still more preferably 0.1 pl or less. If the volume of the ink droplet is 1 pl or less, the influence of air resistance is notably increased so that the flying speed of the ink droplet is drastically reduced. As the flying speed of the ink droplet is reduced, a problem that the ink droplet becomes fine mist is caused so that the ink droplet may not adequately reach the medium. Therefore, it is especially difficult to set the distance between the nozzle face and the medium large when the volume of the ink droplet is small. According to the arrangement 3, the distance between the nozzle face and the medium can be set adequately large even when the volume of the droplet is small. Therefore, this arrangement enables adequate printing of a high resolution image.

(Arrangement 4) The saturated vapor pressure of the main component of the ink at a temperature of 25° C. is about 1/20 atm or less. The saturated vapor pressure is, for example, 10 mmHg or less, preferably 5 mmHg or less. It is preferable that the vapor pressure of the entire ink is, for example, 1/20 or less of the normal atmospheric pressure.

The inventor of the present invention intensely studied and found that, in an inkjet printer which is structured to eject liquid ink, it is impossible to suitably reduce the air resistance even though it is tried to reduce the pressure because the range of suitable pressure allowing stable use of ink is small. In case of using conventionally known ink, it is difficult to sufficiently reduce the pressure even when it is tried to reduce the pressure of the area between the nozzles and the medium because components of the ink are affected by the vapor pressure so as to evaporate so that the characteristics of ink vary. Therefore, since the pressure cannot be sufficiently reduced even by simply using a decompression means, it is difficult to sufficiently and suitably reduce influence of air resistance on ink droplets.

However, according to this arrangement, it is possible to adequately reduce the influence of vapor pressure of the ink. In addition, this can suitably reduce the pressure of the area between the nozzles and the medium. According to the arrangement, therefore, the influence of air resistance on the ink droplets can be sufficiently and suitably reduced. Therefore, this allows the distance between the nozzle face and the medium to be set adequately and sufficiently large.

The main component of the ink means a component making up the highest percentage of the ink. The contained amount of the main component in the ink is, for example, 50% or more, preferably 65% or more (for example, 65-85%). The saturated vapor pressure of the main component in the ink means a saturated vapor pressure under environment for the printing. For example, the saturated vapor pressure in this example may be a vapor pressure in normal atmospheric pressure, i.e. 1 atm, at a temperature of 25° C.

(Arrangement 5) The ink contains at least one of monomer and oligomer as the its main component and is curable by polymerization of the main component. The ink is polymerizable and curable by irradiation of light (for example, visible light), ultraviolet light, electron beam, radiation ray, or heat. For example, the ink may be UV curable ink or thermosetting ink. The ink may be ink that is curable by irradiation of electron beam.

When the saturated vapor pressures of components (volatile components) of the ink are low, it is too much time to dry the ink by evaporation of the components of the ink similarly to water-base inks and solvent inks. If the medium is heated for promoting the evaporation, it is required to heat to a high temperature so that the medium may be deformed by the heat. If the ink cannot be sufficiently dried, bleeding may be caused, leading to reduction in printing quality. Therefore, if the ink used in the printing system according to the embodiment of the present invention is of a type that is fixed to the medium by drying, it may be difficult to adequately conduct the printing.

According to this arrangement, however, since ink which is curable by polymerization of the main component by irradiation of light (for example, visible light), ultraviolet light, electron beam, radiation ray, or heat is used, the ink can be fixed to the medium without evaporation of components of the ink. Therefore, according to this arrangement, adequate printing can be conducted using ink of which components have low saturated vapor pressures.

It should be noted that the ink may contain both monomer and oligomer as its main components. This, i.e. the ink contains both monomer and oligomer as its main components, means that the total contained amount of the monomer and the oligomer is larger than any of other components, for example. In this case, the contained amount of the main component may be the total contained amount of the monomer and the oligomer.

The ink further contains an initiator for the polymerization, for example. The saturated vapor pressure of the initiator is, for example, 10 mmHg or less, preferably 5 mmHg or less. According to this arrangement, the influence of the vapor pressure of the ink can be further suitably restricted, for example. Therefore, the influence of air resistance on the ink droplets can be further suitably reduced, for example.

The ink further contains, for example, a pigment, dispersant, an antigelling agent, a surface conditioner, and the like. The ink may further contain various additives. It is preferable that the saturated vapor pressure of any of substantial components is 10 mmHg or less. The saturated vapor pressure of any of substantial components is further preferably 5 mmHg or less.

The substantial component means a component remaining in the ink as composition of the ink in the inkjet head, for example. The substantial components of the ink are preferably all of the compositions of the ink. In practice, the substantial components of the ink may be a part occupying 95% or more of the compositions, except a part of which contained amount is small.

(Arrangement 6) The saturated vapor pressure of each component occupying about 5% or more of the ink at a temperature of 25° C. is about 1/20 atm or less. The saturated vapor pressure is, for example, 10 mmHg or less, preferably 5 mmHg or less. According to this arrangement, for example, the influence of the vapor pressure of the ink can be suitably restricted. When there are a plurality of components each occupying about 5% or more of the ink, the saturated vapor pressure of any of these components at a temperature of 25° C. is preferably in the aforementioned range.

(Arrangement 7) The decompression means reduces the pressure of the area between the medium and the nozzles to about 0.5 atm or less. The decompression means preferably reduces the pressure of the area between the medium and the nozzles to 0.1 atm or less, more preferably 0.01 atm or less. This arrangement can largely reduce the influence of air resistance. In addition, according to this arrangement, it is possible to adequately conduct the printing even when the volume of the droplet is small.

(Arrangement 8) An inkjet printer of a type printing in the inkjet method, includes: an inkjet head having nozzles for ejecting ink to a medium; and a medium supporting portion for supporting the medium to face the nozzles of the inkjet head by supporting the back surface of the medium opposite to the print surface, wherein the distance between the surface supporting the medium of the medium supporting portion and the nozzle face of the inkjet head is about 5 mm or more, and wherein the pressure at least of the area between the medium and the nozzle face of the inkjet head is reduced to a value lower than the normal atmospheric pressure. This arrangement can achieve the same effects as those of the arrangement 1, for example.

(Arrangement 9) A printing method for printing in the inkjet method, includes: supporting a medium to face nozzles of an inkjet head by supporting the back surface of the medium opposite to the print surface such that the surface supporting the medium and the nozzle face of the inkjet head is spaced apart from each other by about 5 mm or more; reducing the pressure at least of an area between the medium and the nozzles of the inkjet head to a value lower than the normal atmospheric pressure; and ejecting ink to the medium from the nozzles of the inkjet head. This arrangement can achieve the same effects as those of the arrangement 1, for example.

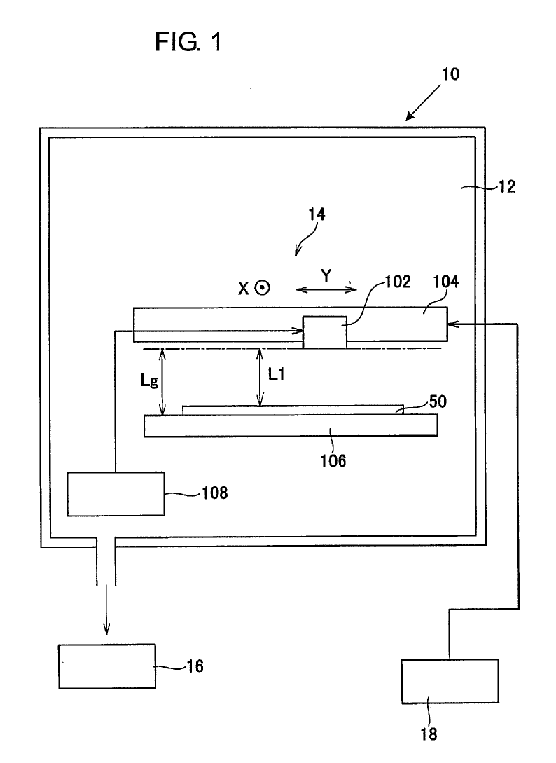

FIG. 1 shows an example of the structure of a printing system 10 according to an embodiment of the present invention. The printing system 10 is a printing system of a type conducting printing in an inkjet printing method onto a medium 50 and includes an inkjet printer 14 and a vacuum pump 16. The printing system 10 may be an industrial printing system for printing outdoor advertisements, posters, or published matters. In this embodiment, the medium 50 is a plane (two-dimensional) medium such as paper, film or fabric.

In the printing system 10 of this embodiment, at least the inkjet printer 14 is disposed within a decompression chamber 12. The decompression chamber 12 is an airtight chamber accommodating the inkjet printer 14 therein and is decompressed by a vacuum pump 16. The printing system 10 conducts printing according to the control of an outside host PC 18. The host PC 18 is a computer for controlling the printing actions of the inkjet printer 14.

The inkjet printer 14 is a printing apparatus for printing in the inkjet method and includes an inkjet head 102, a guide rail 104, an ink cartridge 108, and a platen 106. The inkjet head 102 is a print head having nozzles for ejecting ink droplets onto a print surface of the medium 50. In this embodiment, the inkjet head 102 ejects ink droplets, each having a volume of about 3 picoliters (hereinafter, referred to as “pl”) or less, from the nozzles. The volume of each ink droplet is preferably 1 pl or less, more preferably 0.5 pl or less, still more preferably 0.1 pl or less.

The inkjet head 102 reciprocates in a Y direction as a predetermined scan direction along the guide rail 104 so that the inkjet head 102 ejects ink droplets at respective positions on the medium 50 in the Y direction. Further, the inkjet head 102 moves in an X direction perpendicular to the Y direction relative to the medium 50 so that the inkjet head 102 ejects ink droplets at respective positions on the medium 50 in the X direction.

The inkjet printer 14 apparently moves the inkjet head 102 in the X direction relative to the medium 50 by, for example, feeding the medium 50. In this case, the inkjet printer 14 further includes rollers or the like for feeding the medium 50. In the inkjet printer 14, the inkjet head 102 may be moved without feeding the medium 50.

The guide rail 104 is a member for guiding the movement of the inkjet head 102 in the Y direction and may move the inkjet head 102 to scan according to a command of the host PC 18. The ink cartridge 108 is a cartridge of storing ink to be ejected from the inkjet head 102 and is connected to the inkjet head 102 to supply ink to the inkjet head 102 via an ink supplying path such as a tube.

The platen 106 is an example of medium supporting portion and supports the medium 50 facing the nozzles of the inkjet head 102. In this embodiment, the platen 106 is a base-like member disposed to face the inkjet head 102 via the medium 50 and holds the medium 50 such that the surface opposite to the print surface is in contact with the upper surface of the platen 106.

In this embodiment, the gap size Lg between the platen 106 and the inkjet head 102 is about 5 mm or more (for example, from 5 to 50 mm). The gap size Lg is a distance between the upper surface of the platen 106 for supporting the medium 50 and the nozzle face of the inkjet head 102, for example, the minimum distance between the surface of the platen 106 which is in contact with the medium and the nozzle face of the inkjet head 102. For example, the gap size Lg is preferably about 10 mm or more (for example, from 10 to 50 mm, preferably from 15 to 30 mm).

According to this embodiment, the distance between the medium 50 and the inkjet head 102 is set to be large, thereby preventing collision between the medium 50 and the inkjet head 102 without using a complex mechanism or the like. Therefore, it is possible to prevent the design of the printing system 10 from becoming complex. Further, it is possible to provide a printing system 10 having high reliability and high maintainability.

As for the medium 50 supported on the platen 106, the distance L1 between the print surface and the nozzle face of the inkjet head 102 is smaller than the gap size Lg for the thickness of the medium 50. The distance L1 is, for example, about 4 mm or more, preferably about 5 mm or more. For example, when the gap size Lg is about 10 mm or more, the distance L1 is, for example, 9 mm or more, preferably about 10 mm or more.

The vacuum pump 16 is an example of decompression means and reduces the inner pressure of the decompression chamber 12 according to the operation of an operator, for example. Therefore, the vacuum pump 16 reduces the pressure in an area between the nozzles of the inkjet head 102 and the medium 50 in the inkjet printer 14 to a value lower than the normal atmospheric pressure. In this embodiment, the vacuum pump 16 reduces the pressure in this area to, for example, about 0.5 atm or less (for example, from about 0.001 to about 0.5 atm), preferably 0.1 atm or less, more preferably 0.01 atm or less. According to this embodiment, because of this decompression, the influence of air resistance to which ink droplets are subjected between the inkjet head 102 and the medium 50 can be suitably reduced. Further, this decompression allows the distance L1 between the nozzle face of the inkjet head 102 and the medium 50 to be set adequately large.

In a variation embodiment of the present invention, the vacuum pump 16 may be structured as a component of the inkjet printer 14. In this case, for example, the inkjet printer 14 itself is the printing system 10. In addition, instead of the decompression chamber 12 accommodating the entire inkjet printer 14, a decompression chamber as a component of the inkjet printer 14 may be provided. For example, the decompression chamber is an airtight chamber surrounding at least an area between the inkjet head 102 and the medium 50. In this case, by reducing the inner pressure of the decompression chamber, the vacuum pump 16 reduces the pressure at the area between the nozzles of the inkjet head 102 and the medium 50 to a value lower than the normal atmospheric pressure. The decompression chamber may be disposed in a printing unit which is detachably attached to the inkjet printer 14. The medium 50 used in the printing system 10 may be a medium having a convexoconcave print surface such as a three-dimensional medium.

Hereinafter, the detail description will be made as regard to ink used in this embodiment. In this embodiment, the ink contains monomer as its main component and is curable by polymerization of the monomer. For example, the ink may be UV curable ink which is curable by polymerization of the monomer when irradiated with ultraviolet light.

In this case, the UV curable ink contains, for example, a pigment, a dispersant, an initiator (sensitizer), an antigelling agent, a surface conditioner, a monomer, and an oligomer. The contained amount of the monomer is, for example, from 65 to 85%, and the contained amount of the oligomer is, for example, from 10 to 20%. The contained amount of the pigment is, for example, about 4% and the contained amount of the initiator is, for example, about 7%. The contained amounts of the dispersant, the antigelling agent, and the surface conditioner are several percents, respectively.

Also in this case, the saturated vapor pressure of the monomer as the main component at a temperature of 25° C. is, for example, about 1/20 atm or less (for example, from 0.01 to 10 mmHg), preferably 5 mmHg or less (for example, from 2 to 3 mmHg). The saturated vapor pressure of the oligomer and the initiator as the major components is also, for example, about 1/20 atm or less (for example, from 0.01 to 10 mmHg), preferably 5 mmHg or less (for example, from 2 to 3 mmHg). The saturated vapor pressure of the other components of which contained amount is 1% or more of the ink is also about 1/20 atm or less (for example, from 0.01 to 10 mmHg), preferably 5 mmHg or less (for example, from 2 to 3 mmHg).

According to this embodiment, influence of the vapor pressure of the ink can be suitably reduced when the pressure in the decompression chamber 12 is reduced by the vacuum pump 16. Therefore, the inner pressure of the decompression chamber 12 can be suitably reduced, thereby sufficiently and suitably reducing the air resistance to which the ink droplets are subjected.

Also in this embodiment, the ink that is curable by polymerization of monomer is used so that the ink can be fixed to the medium 50 without evaporation of components of the ink. According to this embodiment, therefore, adequate printing can be conducted using ink of which components have low saturated vapor pressures.

As the ink that is curable by polymerization of monomer, for example, thermosetting ink that is curable by heating or ink that is curable by irradiation of light (visible light or the like) other than ultraviolet light, electron beam, or radiation ray may be used. In these cases, the saturated vapor pressures of respective components are preferably the same as or similar to the saturated vapor pressures as mentioned above. Accordingly, similarly to the UV curable ink, adequate printing can be conducted using ink of which components have low saturated vapor pressures.

As the ink, ink containing a component other than monomer as its main component may be used. For example, ink containing oligomer as its main component may be used. Further, ink containing both monomer and oligomer as its main components may be used. In these cases, the saturated vapor pressure of the main component is preferably about 1/20 atm or less, for example, 10 mmHg or less, more preferably 5 mmHg or less.

According to this embodiment, the area between the nozzles of the inkjet head 102 and the medium 50 can be suitably decompressed. Accordingly, the influence of air resistance to which the ink droplets are subjected can be restricted, thus allowing the distance L1 between the nozzle face of the inkjet head 102 and the medium 50 to be set adequately large. Hereinafter, the influence of air resistance to which the ink droplets are subjected will be further described in detail.

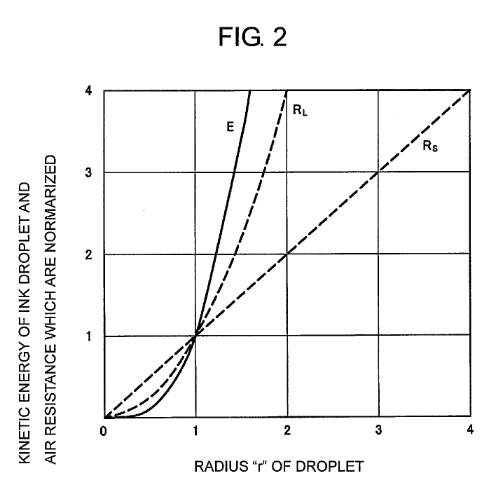

FIG. 2 is a graph for explaining the relationship between kinetic energy of an ink droplet and air resistance. In this graph, respective components of the kinetic energy and the air resistance are normalized such that curves and a line indicating the respective components intersect at a coordinate point (1, 1).

When the speed of the ink droplet is represented by “v”, the kinetic energy “E” of the droplet is E=(½) mv². When the radius of the droplet is represented by “r”, the mass “m” of the droplet is proportional to “r³” because the mass “m” is proportional to the volume. Therefore, if the speed “v” of the droplet is constant, the kinetic energy of the droplet is proportional to “r³”.

It is known that the air resistance to which droplet is subjected includes air resistance component R_{S} which is proportional to the radius “r” of the droplet and air resistance component R_{L} which is proportional to the sectional area of the droplet. Since the sectional area of the droplet is proportional to “r²”, the air resistance component R_{L} is proportional to “r²”.

When the radius “r” of the droplet is enough small, the air resistance component R_{S} is larger than the air resistance component R_{L} so that the droplet is subjected to air resistance which is substantially proportional to the radius “r”. On the other hand, when the radius “r” of the droplet is enough large, the air resistance component R_{L} is larger than the air resistance component R_{S} so that the droplet is subjected to air resistance which is substantially proportional to the radius “r” squared (r²). Further, when the radius “r” of the droplet is a size between the both components, the droplet is subjected to air resistance in which the air resistance component R_{S} and the air resistance component R_{L} are combined. In this case, the air resistance to which the ink droplet is subjected is a value in a region between the curve indicating the air resistance component R_{L} and the line indicating the air resistance component R_{S}.

Taking the relationship between the kinetic energy of an ink droplet and the air resistance into consideration, as can be seen from the graph, the kinetic energy E of the droplet is large as compared to the air resistance when the radius “r” is increased. When the kinetic energy E of the droplet is enough large as compared to the air resistance, the droplet is hardly affected by the air resistance. On the other hand, when the radius “r” is small, the kinetic energy E of the droplet is small as compared to the air resistance. The smaller the radius “r” is, the easier the droplet is affected by the air resistance.

The speed of ejected ink droplet decelerates with time according to the balance between the kinetic energy of the ink droplet and the air resistance. As the influence of air resistance is increased, the ejected ink droplet immediately decelerates so that, for example, the ink droplet becomes fine mist. As a result, it is difficult to ensure enough flying distance of the droplet when the radius “r” of the droplet is small.

However, it is necessary to reduce the volume of ink droplets in order to achieve the printing of a high resolution image which has been desired recently. Therefore, it is further difficult to increase the flying distance of ink droplets. In addition, as a result of this, it is also difficult to set the gap size Lg to be large in the atmosphere.

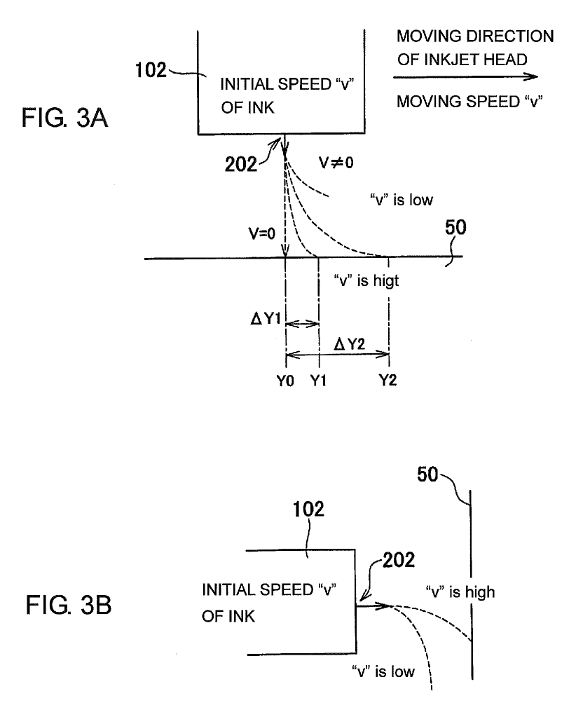

FIGS. 3A and 3B are illustrations showing an example of influence of air resistance on ink droplets. In the inkjet printer 14 of this embodiment (see FIG. 1), the inkjet head 102 has a plurality of nozzles. In the following description, however, description will be made as regard to an ink droplet ejected from only one nozzle 202 of the inkjet head 102 for ease of explanation;

FIG. 3A schematically shows an example of state of an ink droplet ejected from the inkjet head 102 which is moving in the Y direction. In this example, the inkjet head 102 ejects the ink droplet downward in a vertical direction at an initial speed “v” from the nozzle 202. The inkjet head 102 moves at a moving speed “V” in the Y direction.

Now, a case that the inkjet head 102 ejects the ink droplet at a point Y0 in the Y direction (Y coordinate) will be considered. In this case, if the moving speed V of the inkjet head 102 is 0, an ink droplet ejected is deposited at a position Y0 in the Y coordinate on the medium 50 without any shift.

However, if the ink is ejected while the inkjet head 102 is moving at the moving speed V as actual printing, the deposition point (arrival point) of the ink droplet shifts from the point Y0 in the Y coordinate. The lower the initial speed “v” of the ink droplet is, the greater the deposition point shifts. For example, assuming that the deposition point in the Y coordinate when the ink droplet is ejected at a certain initial speed is Y1 and the deposition point in the Y coordinate when the ink droplet is ejected at an initial speed lower than the certain initial speed is Y2, the shifting amount of the latter case ΔY2=Y2−Y0 is greater than the shifting amount of the former case ΔY1=Y−Y0.

For this, the inkjet print 14 controls timing of ejecting ink by previously calculating the shifting amount of the deposition point based on the moving speed “V” of the inkjet head 102, the initial speed “v” of the ink droplet, the distance between the inkjet head 102 and the medium 50, and the like. Therefore, the inkjet printer 14 deposits the ink droplet to a desired position on the medium 50.

However, when the ink is ejected in a state that influence of air resistance is great, for example, in the atmosphere, the speed of the ink droplet decelerates according to the balance between the kinetic energy of the ink droplet and the air resistance in a time between the ejection from the inkjet head 102 and the deposition on the medium 50. If the gap size Lg between the platen 106 and the inkjet head 102 is large, the influence of air resistance on the shifting amount of the deposition position is great so that it is difficult to suitably previously calculate the shifting amount. Accordingly, in the atmosphere, it is difficult to set the gap size Lg to be larger than a certain distance.

For example, when the volume of the droplet is 1 pl or less, there may be not only a problem that the deposition point is shifted but also a problem that the ink droplet becomes fine mist because the speed is reduced to too low due to influence of air resistance. Therefore, when influence of air resistance on the ink droplet is great, for example, as in the atmosphere, ink droplet of which volume is small may be difficult be ejected. As a result, when the volume of the droplet is small, it is further difficult to set the gap size Lg to be large.

To reduce the influence of air resistance, it can be considered that making the kinetic energy of ink droplet larger by increasing the mass of the ink droplet or the initial speed of ejection is effective. However, it is necessary to reduce the size of ink droplets in order to achieve the printing of a high resolution image which has been desired recently. Therefore, it is difficult to increase the mass of the ink droplet. Also for the initial speed of ejection, it is not easy to increase the initial speed of ejection because various optimization measures must be conducted in the structure of the inkjet printer. If the initial speed of ejection of small droplet is increased too much, the shape of droplet maintained by the surface tension cannot be maintained so as to spoil the suitable ejection.

FIG. 3B schematically shows an example of state of an ink droplet in case that the ink is ejected in a horizontal direction. In the inkjet printer 14, the inkjet head 102 may be adapted to eject the ink from the nozzle 202 in the horizontal direction.

Also in this case, there is a problem that the deposition point is shifted. In addition, when the volume of the droplet is small, there is also a problem that the ink droplet becomes fine mist because the speed is reduced to too low due to the balance between the kinetic energy of the droplet and the air resistance. In this case, the droplet is subjected to gravity acting downward in a vertical direction in addition to the air resistance. Accordingly, as the speed of the droplet is reduced due to the air resistance, the droplet falls downward in the vertical direction rather than moving toward the medium 50. In this case, therefore, it is further difficult to set the distance between the inkjet head 102 and the medium 50 to be large. Also in this case, similarly to the case as described with reference to FIG. 3A, it is difficult to set the gap size Lg to be larger than a certain distance.

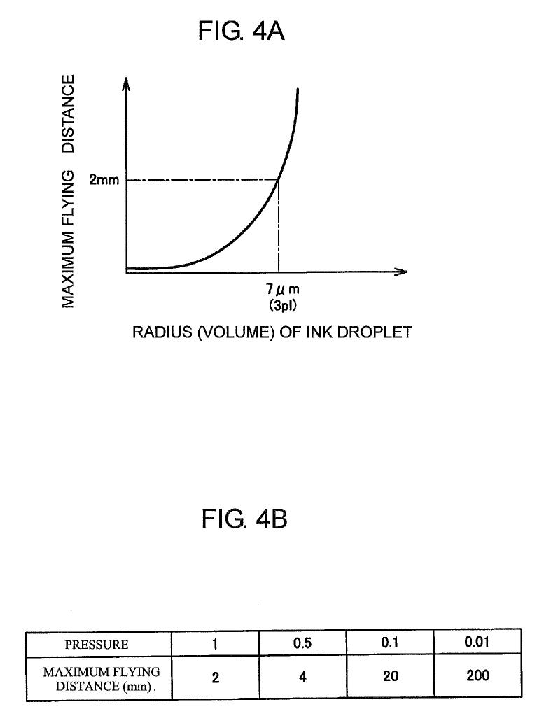

FIGS. 4A and 4B are illustrations for explaining the flying distance of the ink droplet. FIG. 4A is a graph showing an example of relationship between the radius of the droplet and the maximum flying distance under the normal atmospheric pressure. As described with regard to FIG. 2, the larger the radius of the ink droplet is, the larger the kinetic energy of the droplet is. When the kinetic energy of the droplet is large, the droplet is hard to be affected by the air resistance. The maximum distance that the droplet can be suitably ejected depends on the radius of the ink droplet. For example, in case shown in the graph, the maximum flying distance of the ink droplet is 2 mm when the radius of the droplet is 7 μm. Accordingly, it is difficult to set the gap size to, for example, about 5 mm or more in the atmosphere.

The droplet of 7 μm in radius corresponds to a droplet of about 3 pl in volume. As can be seen from the graph, when the volume of the droplet is 1 pl or less, the maximum flying distance is significantly reduced, for example, 0.5 mm or less. Accordingly, it is further difficult to set the gap size Lg to, for example, about 5 mm or more in the atmosphere.

FIG. 4B is a table showing an example of relationship between the pressure in the area between the nozzle 202 of the inkjet head 102 and the medium 50 and the maximum flying distance of the droplet, of a case that the volume of the droplet is 3 pl. When the volume of the droplet is 3 pl, the maximum flying distance is about 2 mm in the normal atmospheric pressure (1 atm) as described in the above with reference to FIG. 4A.

When the pressure of the area between the nozzle 202 and the medium 50 is reduced to about 0.5 atm, about 0.1 atm, and about 0.01 atm by means of the structure of the printing system 10 of this embodiment, the influence of air resistance is reduced so that the maximum flying distance is increased to, for example, 4 mm, 20 mm, and 200 mm. According to this embodiment, the decompression by the vacuum pump 16 allows to set the gap size Lg to be enough large.

Similarly, for example, even in a case of the ink droplet having a small volume, reduction in pressure of the area between the nozzle 202 and the medium 50 prevents the ink from becoming fine mist and increases the maximum flying distance of the droplet, but description of concrete numeric values is omitted. For example, even when the volume of the ink droplet is 1 pl or less, the maximum flying distance of about 5 mm or more, further of about 10 mm or more can be obtained by sufficiently reducing the pressure in the area between the nozzle 202 and the medium 50. Therefore, even when the volume of the ink droplet is smaller than the above case, the gap size Lg can be set to be enough large by reducing the pressure by the vacuum pump 16 similarly to the aforementioned embodiment.

Though the present invention has been described with regard to the embodiments, the technical scope of the present invention is not limited to the scope described in the aforementioned embodiments. It will be apparent to those skilled in the art that various modifications and improvements can be applied to the aforementioned embodiments. It is apparent from the claims of the present invention that embodiments with such modifications and improvements are within the technical scope of the present invention.

What is claimed as new and desired to be secured by Letters Patent of the United States is:

1. A printing system comprising:
an inkjet head having nozzles configured to eject ink to a print surface of a medium, the nozzles having a nozzle surface on which openings of the nozzles exist;
a medium supporting portion having a supporting surface configured to support the medium at a back surface of the medium opposite to the print surface, the print surface facing the nozzles of the inkjet head, a distance between the nozzle face and the supporting surface of the medium supporting portion being about 5 mm or more; and
a decompressor configured to reduce a pressure in an area between the medium and the nozzles to be a pressure value lower than atmospheric pressure.

2. The printing system according to claim 1, wherein the distance between the nozzle face and the supporting surface of the medium supporting portion is about 10 mm or more.

3. The printing system according to claim 1, wherein the nozzles are configured to eject ink droplets each having a volume of about 3 picoliters or less.

4. The printing system according to claim 1, wherein a saturated vapor pressure of a main component of the ink at a temperature of 25° C. is about 1/20 atm or less.

5. The printing system according to claim 4, wherein the ink contains at least one of monomer and oligomer as the main component and is curable due to polymerization of the main component.

6. The printing system according to claim 1, wherein a saturated vapor pressure at 25° C. of each component occupying about 5% or more of the ink is about 1/20 atm or less.

7. The printing system according to claim 1, wherein the decompressor is configured to reduce the pressure in the area between the medium and the nozzles to be about 0.5 atm or less.

8. An inkjet printer comprising:
an inkjet head having nozzles configured to eject ink to a print surface of a medium, the nozzles having a nozzle surface on which openings of the nozzles exist, a pressure in an area between the medium and the nozzles being reduced to be a pressure value lower than atmospheric pressure; and
a medium supporting portion having a supporting surface configured to support the medium at a back surface of the medium opposite to the print surface, the print surface facing the nozzles of the inkjet head, a distance between the nozzle face and the supporting surface of the medium supporting portion being about 5 mm or more.

9. A method for printing comprising:
supporting a medium at a back surface of the medium opposite to a print surface, a distance between a nozzle surface on which openings of nozzles exist and a supporting surface supporting the medium being about 5 mm or more;
reducing a pressure in an area between the medium and the nozzles to be a pressure value lower than atmospheric pressure; and
ejecting ink from the nozzles to the print surface of the medium.
